(19) United States
(12) Patent Application Publication
(10) Pub. No.: US 2010/0162277 A1
(43) Pub. Date: Jun. 24, 2010

(54) APPARATUS AND METHOD FOR EXECUTING ROBOT APPLICATION PROGRAM

(75) Inventors: Seung-Ik LEE, Daejeon (KR); Sung Hoon Kim, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute of Daejeon, Daejeon (KR)

(21) Appl. No.: 12/498,187

(22) Filed: Jul. 6, 2009

(30) Foreign Application Priority Data
Dec. 22, 2008 (KR) 10-2008-0131787

(51) Int. Cl. G06F 9/46

(52) U.S. Cl. 719/332; 719/331; 901/30; 901/46

(57) ABSTRACT

An apparatus for executing a robot application program includes a robot application execution device to which an operating system supporting a dynamic library to execute the robot application program is mounted; a robot device unit having various sensors and effectors; a plug-in storage for storing therein plug-ins forming the dynamic library; and a robot application program storage for storing therein the robot application program. Each plug-in is a dynamically loadable file implementing functions of the robot application program by modules.

### CROSS-REFERENCE(S) TO RELATED APPLICATION(S)

The present invention claims priority of Korean Patent Application No. 10-2008-0131787, filed on Dec. 22, 2008, which is incorporated herein by reference.

### FIELD OF THE INVENTION

The present invention relates to a method and apparatus for executing a robot application program; and more particularly, to a method and apparatus for dynamically reconfiguring a robot software during its execution, thereby using the robot software immediately.

### BACKGROUND OF THE INVENTION

A robot is a platform having a number of hardware devices, and a robot application program to control the robot and to provide useful services to a user is created based on such platform. In general, such robot application program operates sensing, recognizing, decision-making and acting in sequence.

The sensing and acting operations to interact with outside cause the robot application program to have different features from those of typical application programs operating only on a computer.

Particularly, since the sensing and acting operations are dependent upon devices attached to the robot, conventional robot application programs inevitably have a drawback in that they operates only for specific robots.

In order to change a robot platform or replace robot software modules, the entire robot application program needs to be recompiled since robot software modules are statically combined in conventional robot application programs. Further, even if modules are dynamically loaded, only functions predefined in the application program can be called among those of modules. Therefore, the conventional robot application programs have low portability and limited usability.

### SUMMARY OF THE INVENTION

In view of the above, the present invention provides a method and apparatus for executing a robot application program, in which each module forming a robot application program is configured as a plug-in and dynamically loaded when necessary, thereby improving portability and performance of the robot application program.

In accordance with an aspect of the present invention, there is provided an apparatus for executing a robot application program, the apparatus including:

a robot application execution device to which an operating system supporting a dynamic library to execute the robot application program is mounted;

a robot device unit having various sensors and effectors;

a plug-in storage for storing therein plug-ins forming the dynamic library; and

a robot application program storage for storing therein the robot application program.

Preferably, each plug-in is a dynamically loadable file implementing functions of the robot application program by modules.

Preferably, the robot application execution device includes a plug-in framework for dynamically loading the plug-ins during execution of the robot application program and registering pluggable objects defined in the plug-ins.

Preferably, the robot application execution device includes an application framework for creating the registered pluggable objects, initializing the created pluggable objects and providing services to the initialized pluggable objects.

Preferably, the application framework includes an application facade for providing interfaces via which the pluggable objects interact with the application framework.

Preferably, the application framework includes a symbol service manager for registering and managing symbols defined in the pluggable objects.

Preferably, the application framework includes a pluggable object manager for managing a list of pluggable objects, among the pluggable objects of the dynamically loaded plug-ins, currently activated by the application framework.

Preferably, the plug-in framework includes a plug-in register function for registering the pluggable objects and a pluggable object register table for managing the registered pluggable objects.

Preferably, the pluggable objects are registered to the pluggable object register table via the plug-in register function.

Preferably, a name, creation function and deletion function of each pluggable object are passed to the pluggable object register table via the plug-in register function.

In accordance with another aspect of the present invention, there is provided a method for executing a robot application program, the method including:

dynamically loading plug-ins in the robot application program;

registering pluggable objects of the dynamically loaded plug-ins to a plug-in framework;

initializing, at an application framework, specific pluggable objects among the registered pluggable objects; and

registering services, provided by the application framework, for the specific pluggable objects.

Preferably, said dynamically loading the plug-ins includes instructing, at the application framework, the plug-in framework to load all plug-ins mounted in a robot or to load specific plug-ins.

The method for executing the robot application program may further include creating the pluggable objects.

Preferably, in said creating the pluggable objects, the plug-in framework is requested to create the pluggable objects, searches for a pluggable object register table managed by the plug-in framework to find register entries of the pluggable objects and calls creation functions registered in the registered entries.

Preferably, in said initializing the specific pluggable objects, services for functions and symbols defined in the pluggable objects are registered.

Preferably, in said registering the services, timer services, symbol services and symbol change notification services are registered.

According to the present invention, since modules forming an application are dynamically loaded, each module can be developed without restricted by the application. Therefore, efficiency in module development can be improved, and development time and efforts can be reduced.

Further, since each module can be simply replaced without recompiling an application program, the application program can be easily upgraded with a low upgrade cost.

Furthermore, since an interface of each module can be used by other modules, portability of an application program between robots can be improved.

### BRIEF DESCRIPTION OF THE DRAWINGS

The above features of the present invention will become apparent from the following description of embodiments, given in conjunction with the accompanying drawings, in which:

FIG. 1 illustrates a block diagram of an apparatus for executing a robot application program in accordance with the present invention;

FIG. 2 illustrates a structure of a plug-in in accordance with the present invention;

FIG. 3 illustrates an application framework in accordance with the present invention;

FIG. 4 illustrates a structure of a plug-in framework in accordance with the present invention;

FIG. 5 illustrates a structure of a pluggable object in accordance with the present invention;

FIG. 6 illustrates an exemplary procedure for dynamically loading a plug-in in accordance with the present invention;

FIG. 7 illustrates an exemplary procedure for creating a pluggable object in accordance with the present invention;

FIG. 8 illustrates an exemplary procedure for initializing a pluggable object in accordance with the present invention;

FIG. 9 illustrates an exemplary procedure for registering timer services in accordance with the present invention;

FIG. 10 illustrates an exemplary procedure for registering symbol services in accordance with the present invention;

FIG. 11 illustrates an exemplary procedure for registering symbol change notification services in accordance with the present invention;

FIG. 12 illustrates an exemplary procedure for registering function call services in accordance with the present invention; and

FIG. 13 illustrates an exemplary execution of a robot application program in a state where various pluggable objects have been registered and initialized in accordance with the present invention.

### DETAILED DESCRIPTION OF THE EMBODIMENT

Hereinafter, embodiments of the present invention will be described in detail with reference to the accompanying drawings, which form a part hereof.

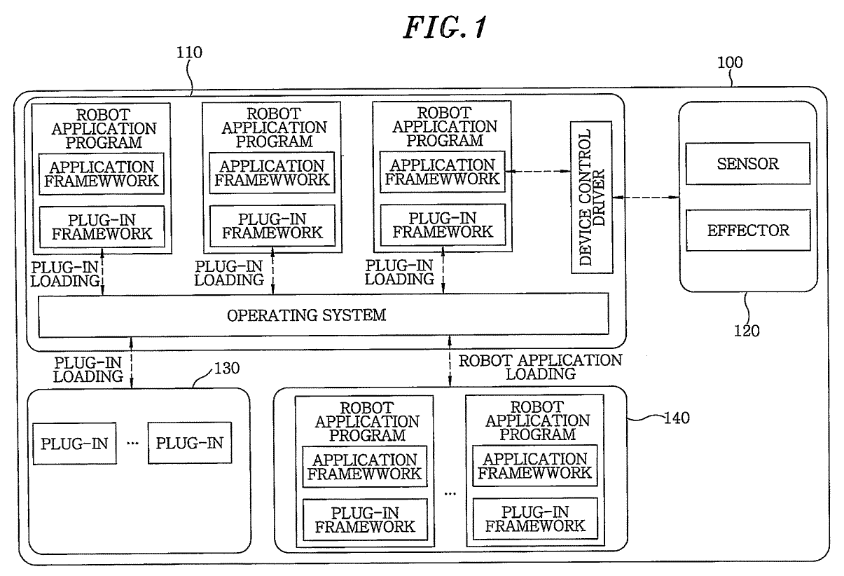

FIG. 1 illustrates a block diagram of an apparatus for executing a robot application program in accordance with the present invention.

Referring to FIG. 1, the robot application program execution apparatus 100 includes a robot application execution unit 110 in which an operating system supporting a dynamic library to execute robot application programs is mounted; a robot device unit 120 having various sensors and output effectors; a plug-in storage 130 for storing therein plug-ins prepared outside or inside a robot; and a robot application program storage 140 for storing therein robot application programs. It should be noted that the plug-in storage 130 and the robot application program storage 140 may be implemented separately or in a single body.

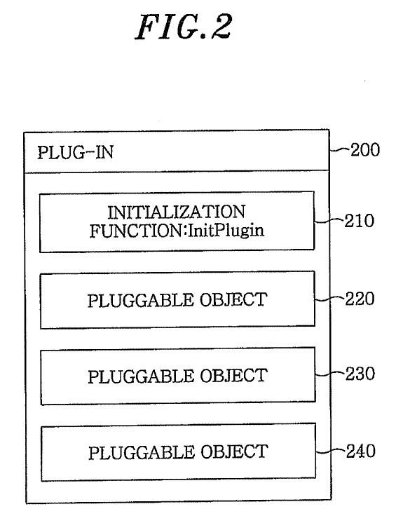

FIG. 2 illustrates a structure of a plug-in in accordance with the present invention. Plug-ins can be shared by several applications and dynamically loaded therein.

Referring to FIG. 2, the plug-in 200 of the present invention may define an initialization function 210 and pluggable objects 220 to 240. The initialization function 210 is firstly called whenever an application loads the plug-in 200. The pluggable objects 220 to 240 are entities actually used in applications to perform desired functions.

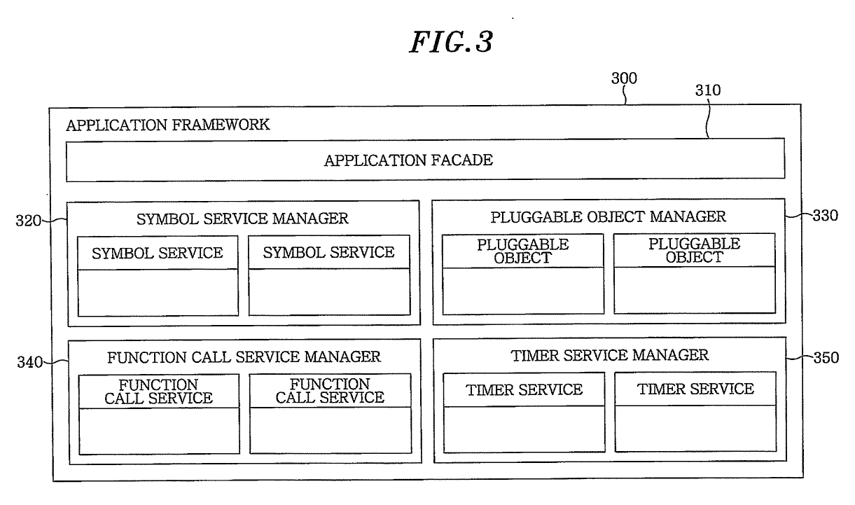

FIG. 3 illustrates an application framework in accordance with the present invention. Every application has an application framework 300.

Referring to FIG. 3, the application framework 300 of the present invention has an application facade 310, a symbol service manager, a pluggable object manager 330, a function call service manager 340 and a timer service manager 350.

The application facade 310 provides an interface for each pluggable object to interact with the application framework 300. When a pluggable object is created, the application facade 310 is passed to the pluggable object and the pluggable object interacts with the application facade 310 only.

The symbol service manager 320 registers and manages symbols defined by each pluggable object. When a pluggable object requests the application facade 310 to register a symbol desired to be exposed to the outside among symbols defined by the pluggable object, the application facade 310 requests the symbol service manager 320 to register the requested symbol.

Further, each pluggable object can request the symbol service manager 320 via the application facade 310 to register services on the symbols registered by the symbol service manager 320, e.g., acquisition of symbol values, assignment of symbol values, notification of changes in symbol values and notification of attempt by other pluggable object to acquire symbol values.

The pluggable object manager 330 manages a list of pluggable objects currently activated by the application framework 300 among pluggable objects of the dynamically loaded plug-ins.

The function call service manager 340 registers and manages functions of each pluggable object. When a pluggable object requests the application facade 310 to register a function desired to be exposed to the outside among functions of the pluggable object, the application facade 310 requests the function call service manager 340 to register the requested function. Each pluggable object can use functions of other pluggable objects by calling the functions registered by the function call service manager 340.

The timer service manager 350 registers and manages periodic calls of functions of pluggable objects. When a pluggable object registers a function to the timer service manager 350 via the application facade 310, the registered function is called periodically for each specific time interval.

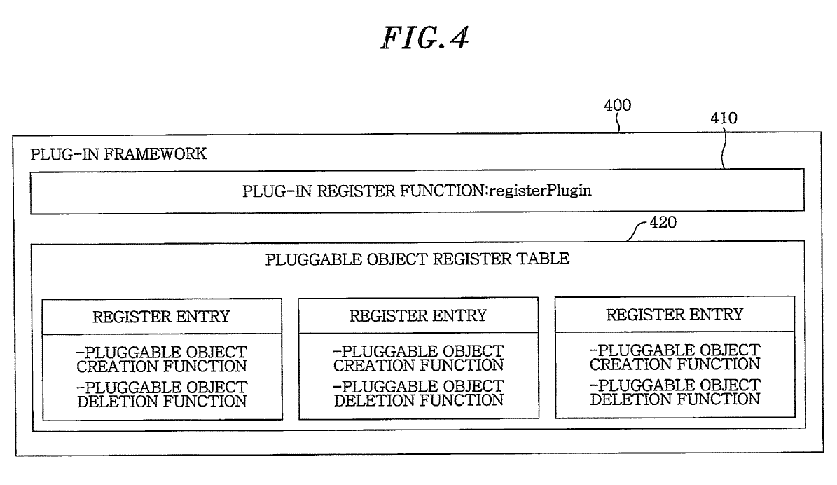

FIG. 4 illustrates a structure of a plug-in framework in accordance with the present invention.

Referring to FIG. 4, the plug-in framework 400 of the present invention includes a plug-in register function 410 and a pluggable object register table 420 for managing registered pluggable objects defined in plug-ins. The plug-in framework 400 loads dynamically loadable plug-ins and registers pluggable objects defined in the plug-ins. To this end, the plug-in framework 400 defines the plug-in register function 410 for use in registration of the pluggable objects. Here, a function signature for the plug-in register function 410 needs to be defined in advance between the plug-ins and the plug-in framework 400.

Each pluggable object is registered via the plug-in register function 410. At this time, a name of the pluggable object, a creation function for the pluggable object and a deletion function for the pluggable objection, which together form the function signature for the plug-in register function 410, are passed via the plug-in register function 410.

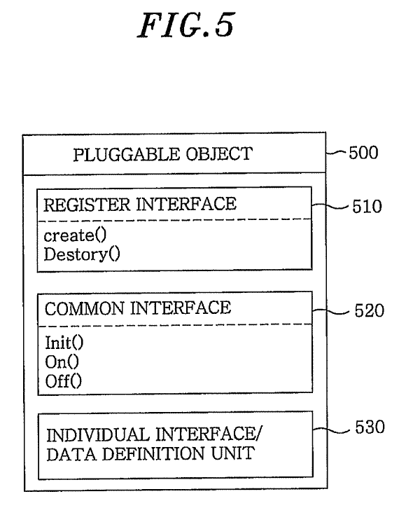

FIG. 5 illustrates a structure of a pluggable object in accordance with the present invention.

Referring to FIG. 5, the pluggable object 500 includes a register interface 510, a common interface 520 and an individual interface/data definition unit 530, which are logically distinguishable.

The register interface 510 defines a pluggable object creation function, e.g., “Create( )”, for creating the pluggable object 500 and a pluggable object deletion function, e.g., “Destroy( )”, for deleting the pluggable object 500. When a plug-in is initialized by the plug-in framework 400, the plug-in passes the pluggable object creation function and the pluggable object deletion function defined in the register interface 510 to the plug-in framework 400. The plug-in framework 400 calls the pluggable object creation function and the pluggable object deletion function to create and delete an entity of the pluggable object 500, respectively. The pluggable object creation function and the pluggable object deletion function need to have specific function signatures predefined between the plug-in framework 400 and the pluggable object 500.

The common interface 520 serves as an interface between the pluggable object 500 and the application framework 300. The common interface 520 at least includes an initialization function, e.g., “Init( )”, for initializing the pluggable object 500, an activation function, e.g., “On( )”, for activating the pluggable object 500 and a deactivation function, e.g., “Off( )”, for deactivating the pluggable object 500.

The register interface 510 and the common interface 520 are essential interfaces for the pluggable object 500 to interact with the application framework 300 and the plug-in framework 400, respectively, and thus need to be defined for all pluggable objects 500.

The individual interface/data definition unit 530 defines major functions and symbols executed in the pluggable object 500, which can be arbitrarily defined by a developer of the pluggable object 500.

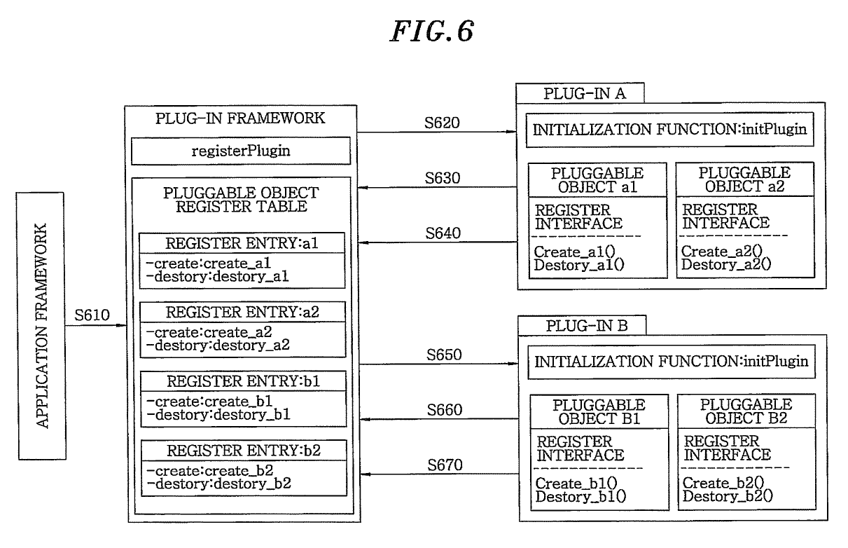

FIG. 6 illustrates an exemplary procedure for dynamically loading a plug-in in accordance with the present invention.

First, the application framework instructs the plug-in framework to load all or some plug-ins by using a plug-in load command (step S610). The plug-in load command specifies plug-ins to be loaded. In the example of FIG. 6, two plug-ins, i.e., a plug-in “A” and a plug-in “B”, are specified to be loaded.

The plug-in framework dynamically loads the plug-in “A” and calls an initialization function “initPlugin” of the plug-in “A” (step S620). At this time, a register function “registerPlugin” of the plug-in framework is passed to the plug-in “A” as a parameter of the initialization function “initPlugin”. The plug-in “A” has two pluggable objects “a1” and “a2”. By using the register function “registerPlugin” received in the step S620, the plug-in “A” registers a name “a1”, a pluggable object creation function “create_a1( )” and a pluggable object deletion function “destroy_a1( )” of the pluggable object “a1” to the plug-in framework (step S630). The plug-in “A” also registers a name “a2”, a pluggable object creation function “create_a2( )” and a pluggable object deletion function “destroy_a2( )” of the pluggable object “a2” to the plug-in framework (step S640). The plug-in framework adds the above-described information to a pluggable object register table.

In a similar manner, the plug-in framework dynamically loads the plug-in “B” and calls an initialization function “initPlugin” of the plug-in “B” (step S650). The plug-in “B” has two pluggable objects “b1” and “b2”. The plug-in “B” registers a name “b1”, a pluggable object creation function “create_b1( )” and a pluggable object deletion function “destroy_b1( )” of the pluggable object “b1” to the plug-in framework (step S660). The plug-in “B” also registers a name “b2”, a pluggable object creation function “create_b2( )” and a pluggable object deletion function “destroy_b2( )” of the pluggable object “b2” to the plug-in framework (step S670). Finally, the plug-in framework becomes to have four registered entries for the pluggable objects “a1”, “a2”, “b1” and “b2”, as shown in FIG. 6.

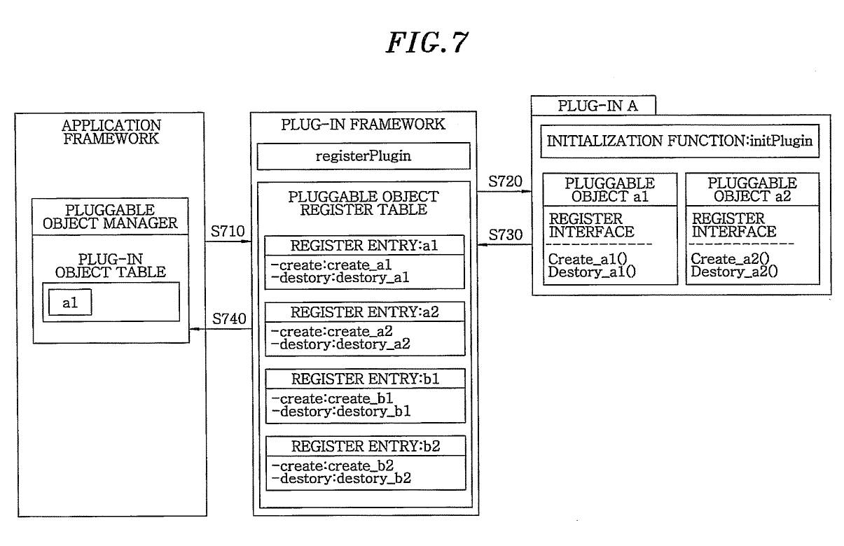

FIG. 7 illustrates an exemplary procedure for creating a pluggable object in accordance with the present invention.

First, the application framework requests the plug-in framework to create a registered pluggable object, e.g., a pluggable object “a1”, (step S710). In response to the request, the plug-in framework searches for a pluggable object register table to find a register entry corresponding to the requested pluggable object, and calls a pluggable object creation function registered in thus found register entry (step S720). Since an actual implementation code of the called pluggable object creation function exists in the plug-in “A” in the example of FIG. 7, a pluggable object creation function “A.al.create_al( )” is called. Then, a pointer for the created pluggable object “a1” is returned to the plug-in framework (step S730). The plug-in framework passes thus received pointer for the pluggable object “a1” to the application framework (step S740). The pointer for the created pluggable object is passed to a pluggable object manager in the application framework and registered in a pluggable object table. Then, an application facade initializes the created pluggable object.

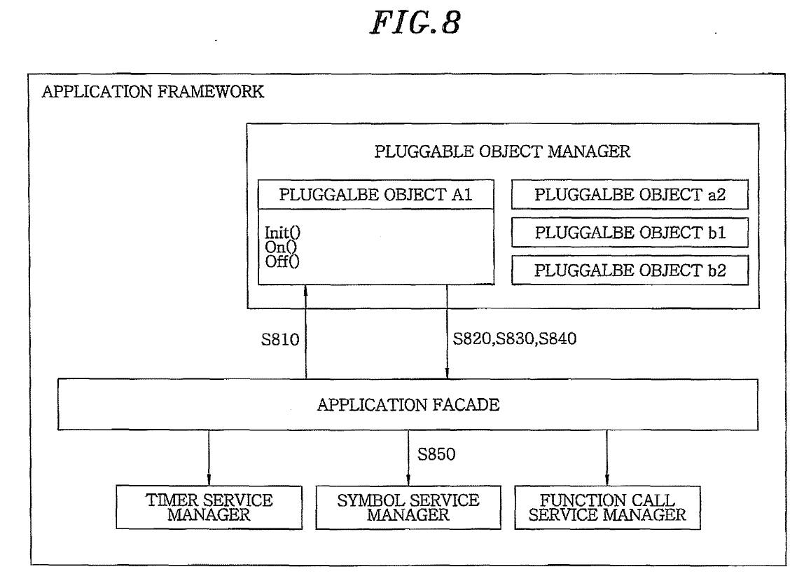

FIG. 8 illustrates a procedure for initializing a pluggable object in accordance with the present invention.

First, the application façade issues an initialization command to a pluggable object “a1” (step S810). In response to the initialization command, the pluggable object “a1” registers functions defined by the pluggable object “a1” to a function call service manager via the application façade (step S820). The pluggable object “a1” also registers symbols defined by the pluggable object “a1” to a symbol service manager (step S830), and further registers periodic calls of functions of the pluggable object “a1” to a timer service manager (step S840). The application framework provides to pluggable objects function call services, symbol services and timer services via the function call service manager, the symbol service manager and the timer service manager, respectively. Therefore, after registering the functions in the step S820, the symbols in the step S830 and the periodic calls in the step S840, the pluggable object “a1” starts to operate as part of an application (step S850).

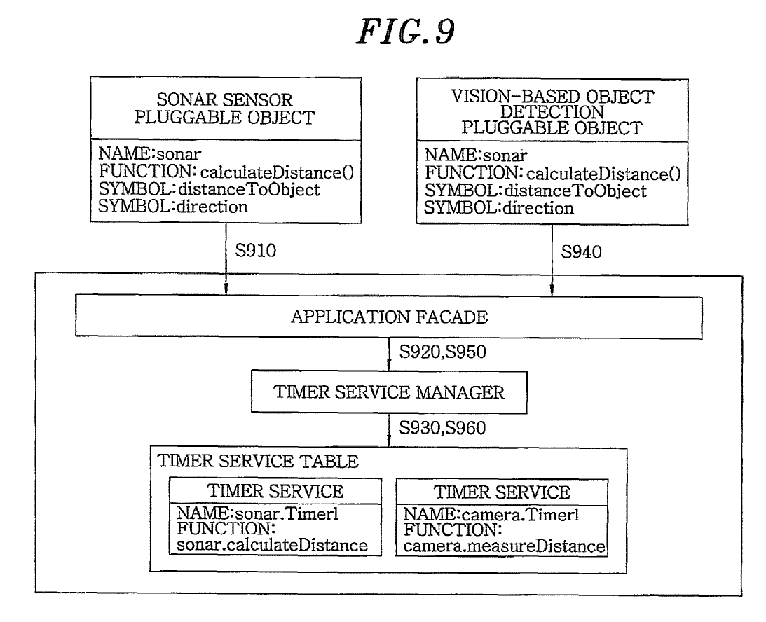

FIGS. 9 to 12 illustrate procedures for registering various services during initialization of pluggable objects.

FIG. 9 illustrates an exemplary procedure for registering timer services in accordance with the present invention. In the example of FIG. 9, a sonar sensor pluggable object and a vision-based object detection pluggable object have been already dynamically loaded in the application framework, and each pluggable object registers a timer service during its initialization process. The sonar sensor pluggable object is a pluggable object that processes sonar sensor information provided from a robot for every 0.1 second to extract a distance and direction to a nearest obstacle from the robot. In order to extract the distance and direction for every 0.1 second, a corresponding function needs to be called for every 0.1 second. That is, a periodic call, i.e., a timer service, for the corresponding function needs to be registered in the application framework.

First, the sonar sensor pluggable object requests the application facade to register a timer service (step S910). In response to the timer service registration request, the application facade passes a name of the pluggable object, i.e., “sonar”, requesting the timer service registration and a name of a function, i.e., “calculateDistance”, relating the requested service to the timer service manager (step S920). Then, the timer service manager adds a corresponding service entry to the timer service table (step S930).

The vision-based object detection pluggable object registers a timer service in a similar manner. The vision-based object detection pluggable object is a pluggable object that analyzes an image taken by a camera to calculate a distance and direction to an object for every 1.0 second. The vision-based object detection pluggable object requests the application facade to register a timer service (step S940). In response to the timer service registration request, the application facade passes a name of the pluggable object, i.e., “camera”, requesting the timer service registration and a name of a function, i.e., “measureDistance”, relating the requested service to a timer service manager (step S950). Then, the timer service manager adds a corresponding service entry to a timer service table (step S960)

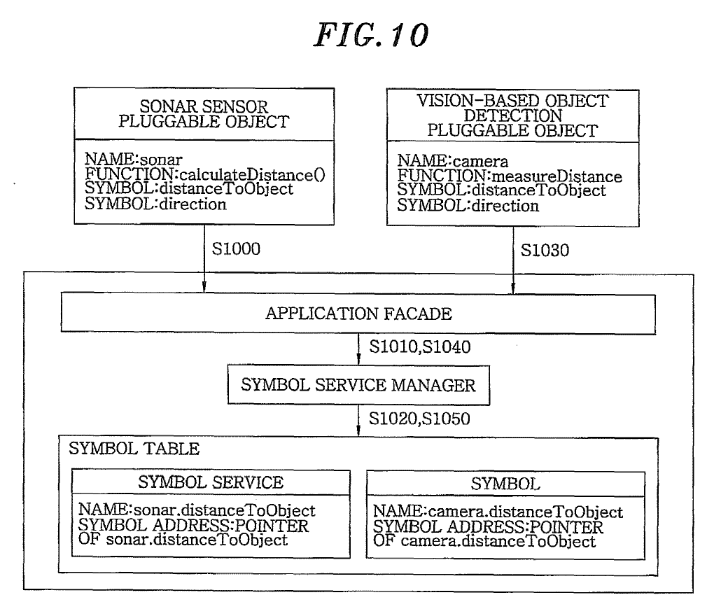

FIG. 10 illustrates an exemplary procedure for registering symbol services in accordance with the present invention. Each pluggable object registers symbols defined by itself, so that other pluggable objects can inquire or change values of the symbols. In the example of FIG. 10, a sonar sensor pluggable object and a vision-based object detection pluggable object register a distance to an obstacle “sonar.distanceToObject” and a distance to an obstacle “camera.distanceToObject”, respectively, thereby allowing other pluggable objects to inquire or change the distances.

First, the sonar sensor pluggable object requests the application facade in the application framework to register a symbol, i.e., the distance “sonar.distanceToObject”, calculated by itself (step S1000). In response to the request, the application facade requests a symbol service manager to register the symbol (step S1010). The symbol service manager adds to the symbol table a symbol service entry corresponding to the requested symbol (step S1020).

In a similar manner, the vision-based object detection pluggable object requests the application facade to register a symbol, i.e., the distance “camera.distanceToObject”, calculated by itself (step S1030). In response to the request, the application facade requests the symbol service manager to register the symbol (step S1040). The symbol service manager adds to the symbol table a symbol service entry corresponding to the requested symbol (step S1050).

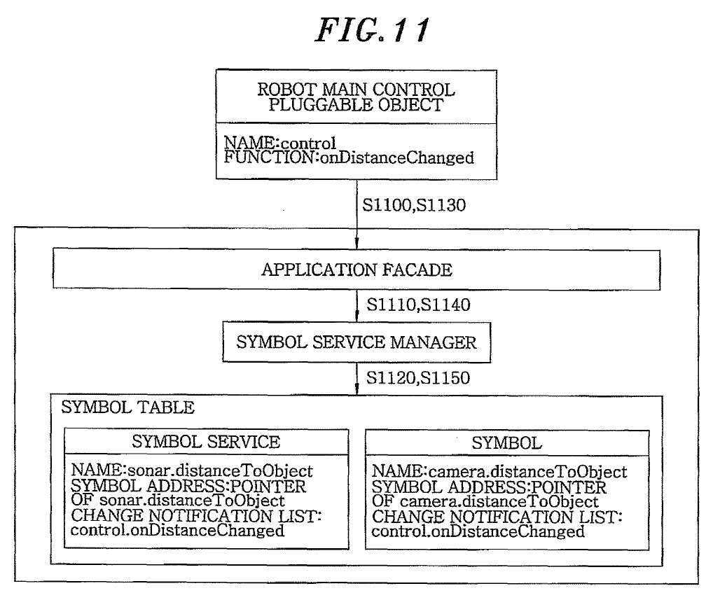

FIG. 11 illustrates an exemplary procedure for registering symbol change notification services in accordance with the present invention.

Each pluggable object can designate a symbol to receive notification when a value of the designated symbol is changed. In the example of FIG. 11, a robot main control pluggable object registers a symbol change notification service. The robot main control pluggable object is a pluggable object that performs a function for avoiding an obstacle based on a location of the obstacle. Therefore, the robot main control pluggable object uses obstacle location information provided by the sonar sensor pluggable object and the vision-based object detection pluggable object. That is, the robot main control pluggable object receives the obstacle location information whenever the sonar sensor pluggable object and the vision-based object detection pluggable object updates it to determine a next motion of a robot.

First, the robot main control pluggable object requests the application facade to register a symbol change notification service for notifying change in a value of a symbol “sonar.distanceToObject” whenever the sonar sensor pluggable object changes it (step S1100). In response to the request, the application façade registers the symbol change notification service to the symbol service manager (step S1110). The symbol service manager adds a function “control.onDistanceChanged” for the symbol change notification service to a change notification list of a symbol service entry corresponding to the symbol “sonar.distanceToObject” in the symbol table (step S1120). When the value of the symbol “sonar.distanceToObject” is changed, the symbol service manager calls the function “control.onDistanceChanged” to notify the robot main control pluggable object of the changed value of the symbol “sonar.distanceToObject”.

In a similar manner, the robot main control pluggable object also registers a symbol change notification service for a symbol “camera.distanceToObject” updated by the vision-based object detection pluggable object. The robot main control pluggable object requests the application façade to register the symbol change notification service for the symbol “camera.distanceToObject” (step S1130). In response to the request, the application façade registers the symbol change notification service to the symbol service manager (step S1140). The symbol service manager adds the function “control.onDistanceChanged” to a change notification list of a symbol service entry corresponding to the symbol “camera.distanceToObject” in the symbol table (step S1150). When the value of the symbol “camera.distanceToObject” is changed, the symbol service manager calls the function “control.onDistanceChanged” to notify the robot main control pluggable object of the changed value of the symbol “camera.distanceToObject”.

By registering an identical function for several symbols, as registering the function “sonar.distanceToObject” for the symbols “sonar.distanceToObject” and “camera.distanceToObject” in the example of FIG. 11, motion control for a robot can be carried out whenever each symbol value is changed while synthetically considering all symbol values.

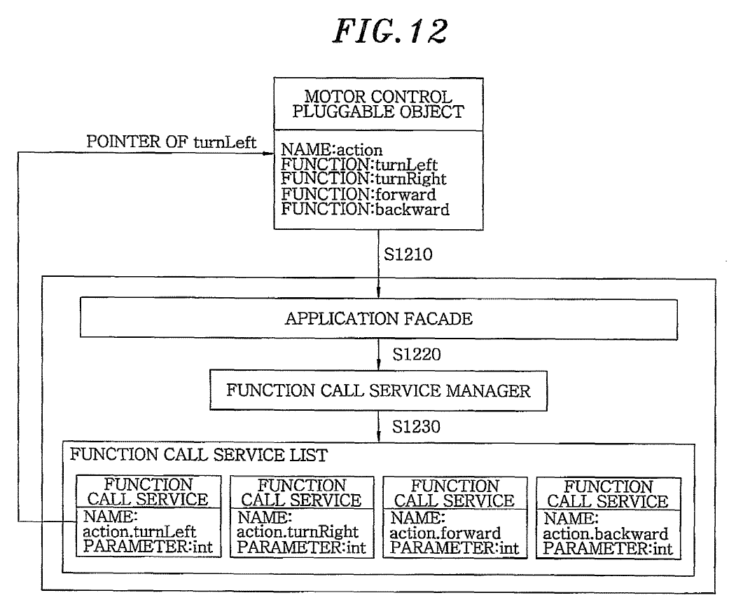

FIG. 12 illustrates an exemplary procedure for registering function call services in accordance with the present invention. According to the present invention, each pluggable object can disclose its functions as well as its symbols, thereby allowing other pluggable objects to use the disclosed functions and symbols. FIG. 12 illustrates disclosure of functions.

A motor control pluggable object of FIG. 12 is a pluggable object that controls robot motion and has robot motion control functions “turnLeft”, “turnRight”, “forward” and “backward”.

The motor control pluggable object requests the application facade to register the robot motion control functions (step S1210). In response to the request, the application façade registers the robot motion control functions to the function call service manager (step S1220). The function call service manager adds the robot motion control functions to a call service list (step S1230).

Other pluggable objects can use thus registered robot motion control functions “turnLeft”, “turnRight”, “forward” and “backward” by calling the functions with an accurate number of parameters.

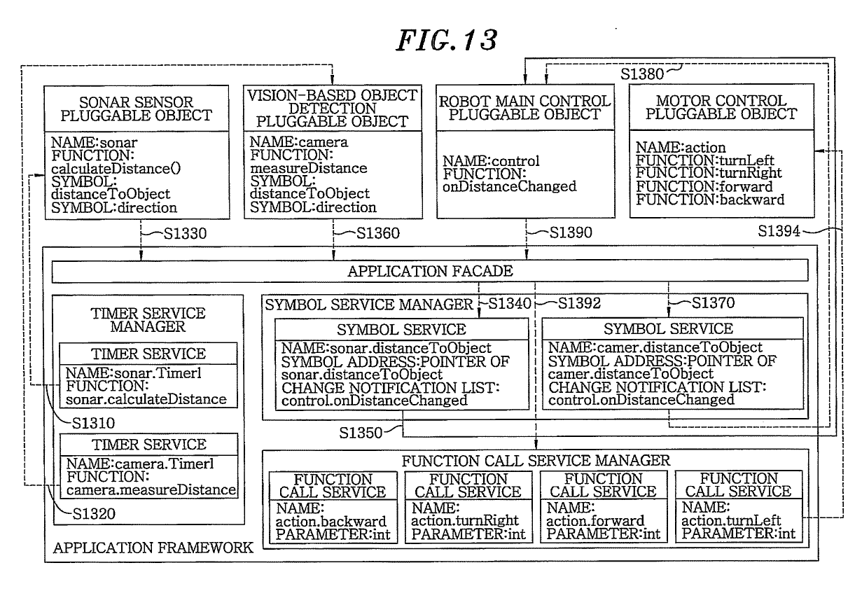

FIG. 13 illustrates an exemplary execution of a robot application program in a state where various pluggable objects have been registered and initialized in accordance with the present invention.

First, a timer service “sonar.Timer1” calls a registered function “sonar.calculateDistance”, which is to be periodically called for every 0.1 second (step S1310). Then, a timer service “camera.Timer1” calls a registered function “camera.measureDistance”, which is also to be periodically called for every 1.0 second (step S1320). In response to the function call in the step S1310, the sonar sensor pluggable object executes the function “sonar.calculateDistance”, and informs the application facade of an updated value of a symbol “sonar.distanceToObject” (step S1330). The application facade requests the symbol service manager to update the value of the symbol “sonar.distanceToObject” (step S1340). In response to the update request, the symbol service manager updates the value of the symbol “sonar.distanceToObject”, and then executes a symbol change notification service for the symbol “sonar.distanceToObject” with reference to a change notification list (step S1350). At this time, since the robot main control pluggable object has registered the symbol change notification service for the symbol “sonar.distanceToObject” in the example of FIG. 13, the symbol service manager calls a function “control.onDistanceChanged” function of the robot main control pluggable object. Though the function “control.onDistanceChanged” is executed, a next robot motion is not determined until a necessary symbol value of the vision-based object detection pluggable object is obtained.

The vision-based object detection pluggable object executes the function “camera.measureDistance” called in the step S1320 to calculate a distance to an obstacle and request the application façade to update a value of a symbol “camera.distanceToObject” (step S1360). The application facade requests the symbol service manager to update the value of the symbol “camera.distanceToObject” (step S1370.)

In response to the update request, the symbol service manager updates the value of the symbol “camera.distanceToObject”, and then executes a symbol change notification service for the symbol “camera.distanceToObject” with reference to the change notification list (step S1380). At this time, since the robot main control pluggable object has registered the symbol change notification service for the symbol “camera.distanceToObject” in the example of FIG. 13, the symbol service manager calls a function “control.onDistanceChanged” function of the robot main control pluggable object.

The robot main control pluggable object calculates a distance to an obstacle more precisely by using the values of the symbols “sonar.distanceToObject” and “camera.distanceToObject” updated in the steps S1350 and S1380, thereby determining the next robot motion.

If it is determined in the step S1390 that the robot needs to turn left, the robot main control pluggable object requests the application facade to call a function “action.turnLeft”. In response to the request, the application facade searches for the function call service manager to find a function call service registered as a name of “action.turnLeft” (step S1392). The function call service manager requests the motor control pluggable object to execute the function “action.turnLeft” (step S1394). In response to the request, the motor control pluggable object controls motors of the robot to physically rotate the robot leftward.

The modules, functional blocks or means used in the embodiments of the present invention may be implemented with a variety of known devices, e.g., as an electronic circuit, an integrated circuit and an ASIC (Application Specific Integrated Circuit). Also, they may be implemented separately, or two or more of them may be implemented integrally.

While the invention has been shown and described with respect to the embodiments, it will be understood by those skilled in the art that various changes and modification may be made without departing from the scope of the invention as defined in the following claims.

What is claimed is:

1. An apparatus for executing a robot application program, the apparatus comprising:
a robot application execution device to which an operating system supporting a dynamic library to execute the robot application program is mounted;
a robot device unit having various sensors and effectors;
a plug-in storage for storing therein plug-ins forming the dynamic library; and
a robot application program storage for storing therein the robot application program.

2. The apparatus of claim 1, wherein each plug-in is a dynamically loadable file implementing functions of the robot application program by modules.

3. The apparatus of claim 2, wherein the robot application execution device includes a plug-in framework for dynamically loading the plug-ins during execution of the robot application program and registering pluggable objects defined in the plug-ins.

4. The apparatus of claim 3, wherein the robot application execution device includes an application framework for creating the registered pluggable objects, initializing the created pluggable objects and providing services to the initialized pluggable objects.

5. The apparatus of claim 4, wherein the application framework includes an application facade for providing interfaces via which the pluggable objects interact with the application framework.

6. The apparatus of claim 4, wherein the application framework includes a symbol service manager for registering and managing symbols defined in the pluggable objects.

7. The apparatus of claim 4, wherein the application framework includes a pluggable object manager for managing a list of pluggable objects, among the pluggable objects of the dynamically loaded plug-ins, currently activated by the application framework.

8. The apparatus of claim 3, wherein the plug-in framework includes a plug-in register function for registering the pluggable objects and a pluggable object register table for managing the registered pluggable objects.

9. The apparatus of claim 8, wherein the pluggable objects are registered to the pluggable object register table via the plug-in register function.

10. The apparatus of claim 9, wherein a name, creation function and deletion function of each pluggable object are passed to the pluggable object register table via the plug-in register function.

11. A method for executing a robot application program, the method comprising:
dynamically loading plug-ins in the robot application program;
registering pluggable objects of the dynamically loaded plug-ins to a plug-in framework;
initializing, at an application framework, specific pluggable objects among the registered pluggable objects; and
registering services, provided by the application framework, for the specific pluggable objects.

12. The method of claim 11, wherein said dynamically loading the plug-ins includes instructing, at the application framework, the plug-in framework to load all plug-ins mounted in a robot or to load specific plug-ins.

13. The method of claim 11 further comprising creating the pluggable objects.

14. The method of claim 13, wherein in said creating the pluggable objects, the plug-in framework is requested to create the pluggable objects, searches for a pluggable object register table managed by the plug-in framework to find register entries of the pluggable objects and calls creation functions registered in the registered entries.

15. The method of claim 11, wherein in said initializing the specific pluggable objects, services for functions and symbols defined in the pluggable objects are registered.

16. The method of claim 11, wherein in said registering the services, timer services, symbol services and symbol change notification services are registered.
